(19) United States
(12) Patent Application Publication
(10) Pub. No.: US 2019/0251526 A1
(43) Pub. Date: Aug. 15, 2019

(54) Method and System for Implementing Digital Currency Tied to Physical Precious Metals

(71) Applicant: Mark Jackson, Castle Rock, CO (US)

(72) Inventor: Mark Jackson, Castle Rock, CO (US)

(21) Appl. No.: 16/256,838

(22) Filed: Jan. 24, 2019

Related U.S. Application Data
(60) Provisional application No. 62/631,345, filed on Feb. 15, 2018.

(51) Int. Cl. G06Q 20/06; H04L 9/06; H04L 9/32

(52) U.S. Cl. CPC G06Q 20/0652; G06Q 20/0655; H04L 2209/56; H04L 9/3236; H04L 2209/38; H04L 9/0637

(57) ABSTRACT

Novel tools and techniques are provided for implementing digital currency, and, more particularly, to methods, systems, and apparatuses for implementing digital currency tied to physical precious metals. In various embodiments, a computing system might receive a request from a user for a digital currency transaction; might validate a blockchain containing a hash of a first block, the first block comprising a first identifier associated with a first piece of a precious metal; might add a block to the blockchain, the added block comprising a second identifier associated with the user and a timestamp of the transaction; might encrypt the added block with a cryptographic hash; and might update the blockchain across a plurality of digital currency data stores. In some cases, the computing system might generate a first block of a blockchain by adding received identifier associated with the first piece of the precious metal.

### CROSS-REFERENCES TO RELATED APPLICATIONS

This application claims priority to U.S. Patent Application No. 62/631,345 (the “'345 application”), filed Feb. 15, 2018 by Mark Jackson (attorney docket no. 1009.01PR), entitled, “Method and System for Implementing Digital Currency Tied to Physical Precious Metals,” the disclosure of which is incorporated herein by reference in its entirety for all purposes.

The respective disclosures of these applications/patents (which this document refers to collectively as the “Related Applications”) are incorporated herein by reference in their entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing digital currency, and, more particularly, to methods, systems, and apparatuses for implementing digital currency tied to physical precious metals.

### BACKGROUND

Conventional cryptocurrencies or digital currencies, which may utilize the inherently secure nature of blockchain technology or the like, are increasing in use and appeal. However, because such conventional cryptocurrencies or digital currencies are not tied to any physical or real-world valuables or similar objects, their value can change in volatile ways, as shown in the recent meteoric rise and subsequent decline in the value of bitcoin and other conventional cryptocurrencies.

Hence, there is a need for more robust and scalable solutions for implementing digital currency, and, more particularly, to methods, systems, and apparatuses for implementing digital currency tied to physical precious metals.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a schematic diagram illustrating a system for implementing digital currency tied to physical precious metals, in accordance with various embodiments.

FIGS. 2A-2D are schematic diagrams illustrating various embodiments of digital currency tied to physical precious metals.

FIG. 3 is a schematic diagram illustrating an embodiment of a blockchain that is tied to a physical piece of a precious metal.

FIG. 4 is a schematic diagram illustrating another embodiment of a blockchain that is tied to physical pieces of precious metals.

FIG. 5 is a flow diagram illustrating a method for implementing digital currency tied to physical pieces of precious metals, in accordance with various embodiments.

FIG. 6 is a flow diagram illustrating another method for implementing digital currency tied to physical pieces of precious metals, in accordance with various embodiments.

FIG. 7 is a block diagram illustrating an exemplary computer or system hardware architecture, in accordance with various embodiments.

FIG. 8 is a block diagram illustrating a networked system of computers, computing systems, or system hardware architecture, which can be used in accordance with various embodiments.

### DETAILED DESCRIPTION OF CERTAIN EMBODIMENTS

Overview

Various embodiments provide tools and techniques for implementing digital currency, and, more particularly, to methods, systems, and apparatuses for implementing digital currency tied to physical precious metals.

In various embodiments, a computing system might access the plurality of instances of the blockchain each from a digital currency data store among the plurality of distributed digital currency data stores. The computing system might receive a request from a user (from user device(s) or the like) for a digital currency transaction; might validate an instance of the blockchain containing a hash of a first block, the first block comprising a first identifier associated with a first piece of a precious metal; might add a block to the blockchain, the added block comprising a second identifier associated with the user and a timestamp of the transaction; might encrypt the added block with a cryptographic hash; and might update the blockchain across a plurality of digital currency data stores.

In some embodiments, a camera(s) might capture an image of the first identifier as physically marked on the first piece of the precious metal. A second computing system might analyze the captured image of the first identifier to generate an encodable version of the first identifier. The second computing system might then send the generated encodable version of the first identifier to the first computing system. According to some embodiments, the first computing system might receive a first identifier associated with a first piece of a precious metal; might generate a first block of a blockchain, by adding the received first identifier to the first block; might encrypt the generated first block of the blockchain using a cryptographic hash; and might store the blockchain in each of a plurality of digital currency data stores. In some cases, receiving the first identifier associated with the first piece of the precious metal might comprise receiving, with the first computing system, the generated encodable version of the first identifier, and adding the received first identifier to the first block might comprise adding the generated encodable version of the first identifier to the first block.

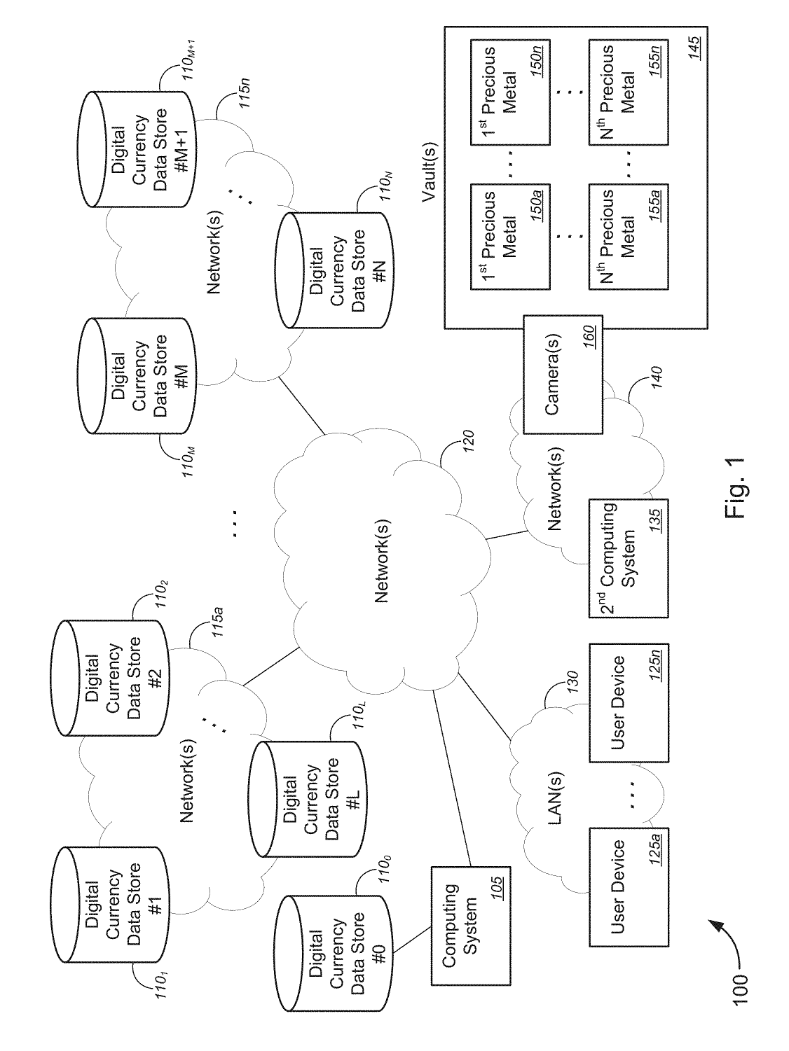

In this manner, a digital currency (also referred to as cryptocurrency) may be tied to a value inherent to precious metals, and thus avoids the arbitrary valuations of typical cryptocurrencies that are wholly virtual and divorced from physical valuations. These and other functions of the system and method are described in greater detail below with respect to FIGS. 1-8.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

Various embodiments described herein, while embodying (in some cases) software products, computer-performed methods, and/or computer systems, represent tangible, concrete improvements to existing technological areas, including, without limitation, blockchain transaction technology, digital currency technology, and/or the like. In other aspects, certain embodiments, can improve the technological field of digital currencies, for example, by tying, with a computing system, one or more pieces of a precious metal to digital currency, and/or the like. These functionalities can produce tangible results outside of the implementing computer system, including, merely by way of example, stability of the value of the digital currency that is tied to physical pieces of precious metals, as opposed to the arbitrary and extremely volatile valuations of digital currencies that are not tied to any real-world valuables, and/or the like, at least some of which may be observed or measured by users and/or other entities.

In an aspect, a method might comprise receiving, with a computing system, a request from a user for a digital currency transaction; validating, with the computing system, a blockchain containing a hash of a first block, the first block comprising a first identifier associated with a first piece of a precious metal; adding, with the computing system, a block to the blockchain, the added block comprising a second identifier associated with the user and a timestamp of the transaction; encrypting, with the computing system, the added block with a cryptographic hash; and updating, with the computing system, the blockchain across a plurality of digital currency data stores.

In some embodiments, encrypting the added block with the cryptographic hash might comprise encrypting the added block to produce a hash value, using a cryptographic hash function comprising one of secure hash algorithm-1 (“SHA-1”) standard, SHA-2 standard, or SHA-3 standard, and/or the like. In some cases, receiving the request from the user for the digital currency transaction might comprise receiving the request from the user via a user device comprising one of a laptop computer, a tablet computer, a smart phone, a mobile phone, a personal digital assistant, or a portable gaming device, and/or the like.

According to some embodiments, validating the blockchain might comprise determining, with the computing system, whether a master instance of the blockchain is accessible, the master instance being an updated instance of the blockchain that has previously been validated; and based on a determination that the master instance of the blockchain is accessible, comparing, with the computing system, the blockchain with the master instance of the blockchain. In such embodiments, the blockchain is validated if the blockchain matches the master instance of the blockchain, wherein adding the block to the blockchain is performed only if the blockchain has been validated. In some cases, comparing the blockchain with the master instance of the blockchain might comprise comparing hash values of one or more blocks of the blockchain with hash values of corresponding one or more blocks of the master instance of the blockchain. In some instances, updating the blockchain across the plurality of digital currency data stores might comprise replacing the master instance of the blockchain with the blockchain after the block has been added and encrypted.

Alternatively, or additionally, validating the blockchain might comprise comparing, with the computing system, the blockchain with each of a plurality of instances of the blockchain, each instance of which is stored in one of the plurality of digital currency data stores. In such embodiments, the blockchain is validated if the blockchain matches a majority of the plurality of instances of the blockchain. In some cases, comparing the blockchain with each of the plurality of instances of the blockchain might comprise comparing hash values of one or more blocks of the blockchain with hash values of corresponding one or more blocks of each of the plurality of instances of the blockchain.

Merely by way of example, the precious metal might include, without limitation, one of gold, silver, platinum, palladium, ruthenium, rhodium, iridium, osmium, rhenium, indium, or electrum (which is a naturally occurring alloy of gold and silver, but can be manufactured), and/or the like. In various embodiments, the piece of the precious metal may be physically stored in a secure vault with other pieces of precious metals. In some instances, the first identifier might be physically marked on the first piece of the precious metal via one of ultraviolet (“UV”) marking, stamping, chemical etching, milling, mechanical engraving, or laser engraving, and/or the like. In some cases, the first identifier comprises at least one of a serial number, an alphanumeric code, a bar code, a quick response (“QR”) code, or a symbol, and/or the like, where the first identifier associated with each of a plurality of pieces of precious metals is unique.

In another aspect, an apparatus might comprise at least one processor and a non-transitory computer readable medium communicatively coupled to the at least one processor. The non-transitory computer readable medium might have stored thereon computer software comprising a set of instructions that, when executed by the at least one processor, causes the apparatus to: receive a request from a user for a digital currency transaction; validate a blockchain containing a hash of a first block, the first block comprising a first identifier associated with a first piece of a precious metal; add a block to the blockchain, the added block comprising a second identifier associated with the user and a timestamp of the transaction; encrypt the added block with a cryptographic hash; and update the blockchain across a plurality of digital currency data stores.

In some embodiments, encrypting the added block with the cryptographic hash might comprise encrypting the added block to produce a hash value, using a cryptographic hash function comprising one of secure hash algorithm-1 (“SHA-1”) standard, SHA-2 standard, or SHA-3 standard, and/or the like. In some cases, receiving the request from the user for the digital currency transaction might comprise receiving the request from the user via a user device comprising one of a laptop computer, a tablet computer, a smart phone, a mobile phone, a personal digital assistant, or a portable gaming device, and/or the like.

According to some embodiments, validating the blockchain might comprise determining whether a master instance of the blockchain is accessible, the master instance being an updated instance of the blockchain that has previously been validated; and based on a determination that the master instance of the blockchain is accessible, comparing the blockchain with the master instance of the blockchain. In such embodiments, the blockchain is validated if the blockchain matches the master instance of the blockchain, wherein adding the block to the blockchain is performed only if the blockchain has been validated. In some cases, comparing the blockchain with the master instance of the blockchain might comprise comparing hash values of one or more blocks of the blockchain with hash values of corresponding one or more blocks of the master instance of the blockchain. In some instances, updating the blockchain across the plurality of digital currency data stores might comprise replacing the master instance of the blockchain with the blockchain after the block has been added and encrypted.

Alternatively, or additionally, validating the blockchain might comprise comparing the blockchain with each of a plurality of instances of the blockchain, each instance of which is stored in one of the plurality of digital currency data stores. In such embodiments, the blockchain is validated if the blockchain matches a majority of the plurality of instances of the blockchain. In some cases, comparing the blockchain with each of the plurality of instances of the blockchain might comprise comparing hash values of one or more blocks of the blockchain with hash values of corresponding one or more blocks of each of the plurality of instances of the blockchain.

Merely by way of example, the precious metal might include, without limitation, one of gold, silver, platinum, palladium, ruthenium, rhodium, iridium, osmium, rhenium, indium, or electrum (which is a naturally occurring alloy of gold and silver, but can be manufactured), and/or the like. In various embodiments, the piece of the precious metal may be physically stored in a secure vault with other pieces of precious metals. In some instances, the first identifier might be physically marked on the first piece of the precious metal via one of ultraviolet (“UV”) marking, stamping, chemical etching, milling, mechanical engraving, or laser engraving, and/or the like. In some cases, the first identifier comprises at least one of a serial number, an alphanumeric code, a bar code, a quick response (“QR”) code, or a symbol, and/or the like, where the first identifier associated with each of a plurality of pieces of precious metals is unique.

In yet another aspect, a system might comprise a plurality of digital currency data stores and a computing system. The computing system might comprise at least one first processor and a first non-transitory computer readable medium communicatively coupled to the at least one first processor. The first non-transitory computer readable medium might have stored thereon computer software comprising a first set of instructions that, when executed by the at least one first processor, causes the computing system to: receive a request from a user for a digital currency transaction; validate a blockchain containing a hash of a first block, the first block comprising a first identifier associated with a first piece of a precious metal; add a block to the blockchain, the added block comprising a second identifier associated with the user and a timestamp of the transaction; encrypt the added block with a cryptographic hash; and update the blockchain across the plurality of digital currency data stores. Each digital currency data store might store an instance of the blockchain among a plurality of instances of the blockchain, the blockchain comprising a plurality of blocks, each block comprising a hash value corresponding to encryption of both data that is encapsulated in said block and a previous hash value corresponding to encryption of data and hash value of a preceding block in the blockchain.

In still another aspect, a method might comprise receiving, with a first computing system, a first identifier associated with a first piece of a precious metal; generating, with first the computing system, a first block of a blockchain, by adding the received first identifier to the first block; encrypting, with the first computing system, the generated first block of the blockchain using a cryptographic hash; and storing, with the first computing system, the blockchain in each of a plurality of digital currency data stores.

According to some embodiments, encrypting the generated first block might comprise encrypting the generated first block to produce a hash value, using a cryptographic hash function comprising one of secure hash algorithm-1 (“SHA-1”) standard, SHA-2 standard, or SHA-3 standard, and/or the like. Merely by way of example, the precious metal might include, without limitation, one of gold, silver, platinum, palladium, ruthenium, rhodium, iridium, osmium, rhenium, indium, or electrum (which is a naturally occurring alloy of gold and silver, but can be manufactured), and/or the like. In various embodiments, the piece of the precious metal may be physically stored in a secure vault with other pieces of precious metals. In some instances, the first identifier might be physically marked on the first piece of the precious metal via one of ultraviolet (“UV”) marking, stamping, chemical etching, milling, mechanical engraving, or laser engraving, and/or the like. In some cases, the first identifier comprises at least one of a serial number, an alphanumeric code, a bar code, a quick response (“QR”) code, or a symbol, and/or the like, where the first identifier associated with each of a plurality of pieces of precious metals is unique.

In some embodiments, the method might further comprise capturing, with an image capture device, an image of the first identifier as physically marked on the first piece of the precious metal; analyzing, with a second computing system, the captured image of the first identifier to generate an encodable version of the first identifier; and sending, with the second computing system, the generated encodable version of the first identifier to the first computing system, wherein receiving the first identifier associated with the first piece of the precious metal comprises receiving, with the first computing system, the generated encodable version of the first identifier, and wherein adding the received first identifier to the first block comprises adding the generated encodable version of the first identifier to the first block.

In another aspect, an apparatus might comprise at least one processor and a non-transitory computer readable medium communicatively coupled to the at least one processor. The non-transitory computer readable medium might have stored thereon computer software comprising a set of instructions that, when executed by the at least one processor, causes the apparatus to: receive a first identifier associated with a first piece of a precious metal; generate a first block of a blockchain, by adding the received first identifier to the first block; encrypt the generated first block of the blockchain using a cryptographic hash; and store the blockchain in each of a plurality of digital currency data stores.

According to some embodiments, encrypting the generated first block might comprise encrypting the generated first block to produce a hash value, using a cryptographic hash function comprising one of secure hash algorithm-1 (“SHA-1”) standard, SHA-2 standard, or SHA-3 standard, and/or the like. Merely by way of example, the precious metal might include, without limitation, one of gold, silver, platinum, palladium, ruthenium, rhodium, iridium, osmium, rhenium, indium, or electrum (which is a naturally occurring alloy of gold and silver, but can be manufactured), and/or the like. In various embodiments, the piece of the precious metal may be physically stored in a secure vault with other pieces of precious metals. In some instances, the first identifier might be physically marked on the first piece of the precious metal via one of ultraviolet (“UV”) marking, stamping, chemical etching, milling, mechanical engraving, or laser engraving, and/or the like. In some cases, the first identifier comprises at least one of a serial number, an alphanumeric code, a bar code, a quick response (“QR”) code, or a symbol, and/or the like, where the first identifier associated with each of a plurality of pieces of precious metals is unique.

In yet another aspect, a system might comprise a plurality of digital currency data stores and a computing system. The computing system might comprise at least one first processor and a first non-transitory computer readable medium communicatively coupled to the at least one first processor. The first non-transitory computer readable medium might have stored thereon computer software comprising a first set of instructions that, when executed by the at least one first processor, causes the computing system to: receive a first identifier associated with a first piece of a precious metal; generate a first block of a blockchain, by adding the received first identifier to the first block; encrypt the generated first block of the blockchain using a cryptographic hash; and store the blockchain in each of a plurality of digital currency data stores. Each digital currency data store might store an instance of the blockchain among a plurality of instances of the blockchain, the blockchain comprising a plurality of blocks, each block comprising a hash value corresponding to encryption of both data that is encapsulated in said block and a previous hash value corresponding to encryption of data and hash value of a preceding block in the blockchain.

In still another aspect, a method might comprise tying, with a computing system, one or more pieces of a precious metal to digital currency.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### Specific Exemplary Embodiments

We now turn to the embodiments as illustrated by the drawings. FIGS. 1-8 illustrate some of the features of the method, system, and apparatus for implementing digital currency, and, more particularly, to methods, systems, and apparatuses for implementing digital currency tied to physical precious metals, as referred to above. The methods, systems, and apparatuses illustrated by FIGS. 1-8 refer to examples of different embodiments that include various components and steps, which can be considered alternatives or which can be used in conjunction with one another in the various embodiments. The description of the illustrated methods, systems, and apparatuses shown in FIGS. 1-8 is provided for purposes of illustration and should not be considered to limit the scope of the different embodiments.

With reference to the figures, FIG. 1 is a schematic diagram illustrating a system 100 for implementing digital currency tied to physical precious metals, in accordance with various embodiments.

In the non-limiting embodiment of FIG. 1, system 100 might comprise a computing system 105, which might include, without limitation, one of a processor on a user device, a server computer, a cloud-based computing system, a distributed computing system, and/or the like. System 100 might further comprise a plurality of digital currency data stores 110 distributed across a plurality of networks 115. As shown in FIG. 1, for example, distributed digital currency data stores #1 110₁, #2 110₂, through #L 110_{L} might be disposed in one or more networks 115a, while distributed digital currency data stores #M 110_{M}, #M+1 110_{M+1}, through #N 110_{N} might be disposed in one or more networks 115n. Although not shown, distributed digital currency data stores #L through #M might be disposed in any of networks 115b through 115n−1. In some cases, each distributed digital currency data store 110 might comprise a database, and in some cases, a local server or computing system that accesses the database in response to requests from external or remote computing systems (e.g., computing system 105, user devices, or the like). In some embodiments, computing system 105 might communicatively couple with a local digital currency data store 1100 and/or one or more of the distributed digital currency data stores 110₁-110_{N} in networks 115 via one or more networks 120. System 100 might further comprise one or more user devices 125a-125n (collectively, “user devices,” “user devices 125,” or the like) disposed in one or more local area networks (“LANs”) 130. In some cases, the one or more user devices 125 might each include, without limitation, one of a laptop computer, a tablet computer, a smart phone, a mobile phone, a personal digital assistant, or a portable gaming device, or the like.

In some embodiments, system 100 might further comprise a second computing system(s) 135 that may be located in one or more networks 140. System 100 might further comprise one or more secure vaults 145 or the like that are used to store a plurality of a first type of precious metals 150a-150n through a plurality of an N^{th} type of precious metals 155a-155n (collectively, “precious metals,” “precious metals 150,” or “precious metals 155,” or the like). Merely by way of example, the precious metals 150 and 155 might each include, without limitation, one of gold, silver, platinum, palladium, ruthenium, rhodium, iridium, osmium, rhenium, indium, or electrum (which is a naturally occurring alloy of gold and silver, but can be manufactured), and/or the like. System 100 might further comprise one or more cameras 160, which might communicatively couple with the second computing system(s) 135 (and in some cases, might also be located in network(s) 140). The one or more cameras 160 might capture images or views of the precious metals 150 or 155 while the precious metals 150 or 155 are being stored in the one or more vaults 145.

According to some embodiments, networks 115a-115n, 120, and 140 might each include, without limitation, one of a local area network (“LAN”), including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network might include an access network of the service provider (e.g., an Internet service provider (“ISP”)). In another embodiment, the network might include a core network of the service provider, and/or the Internet.

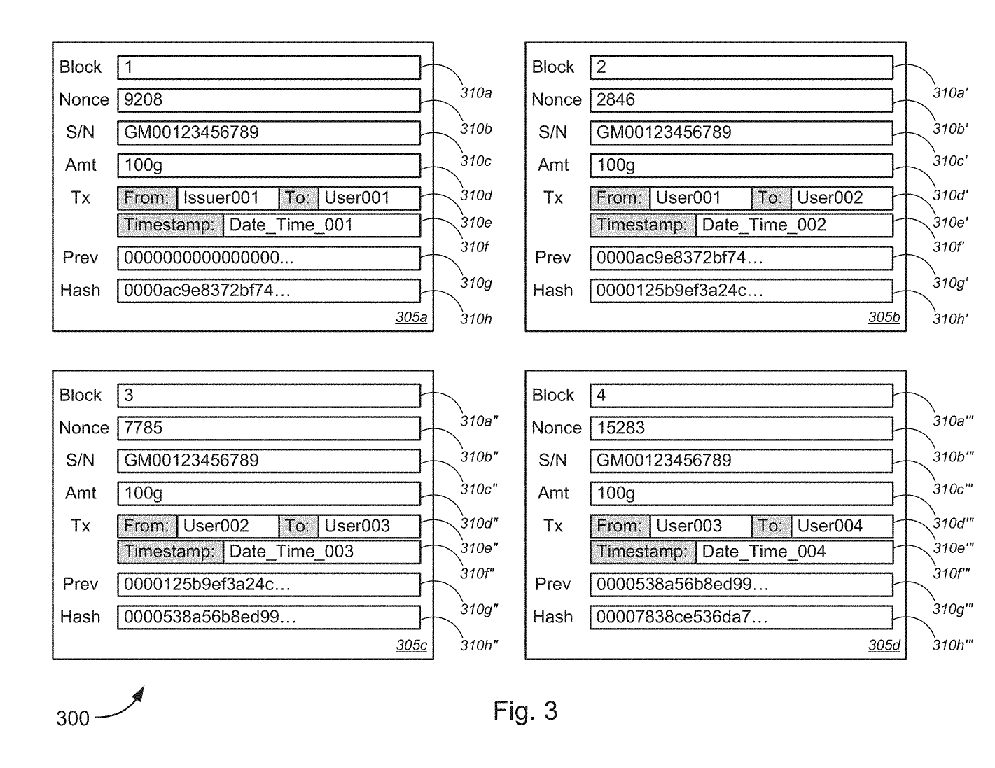

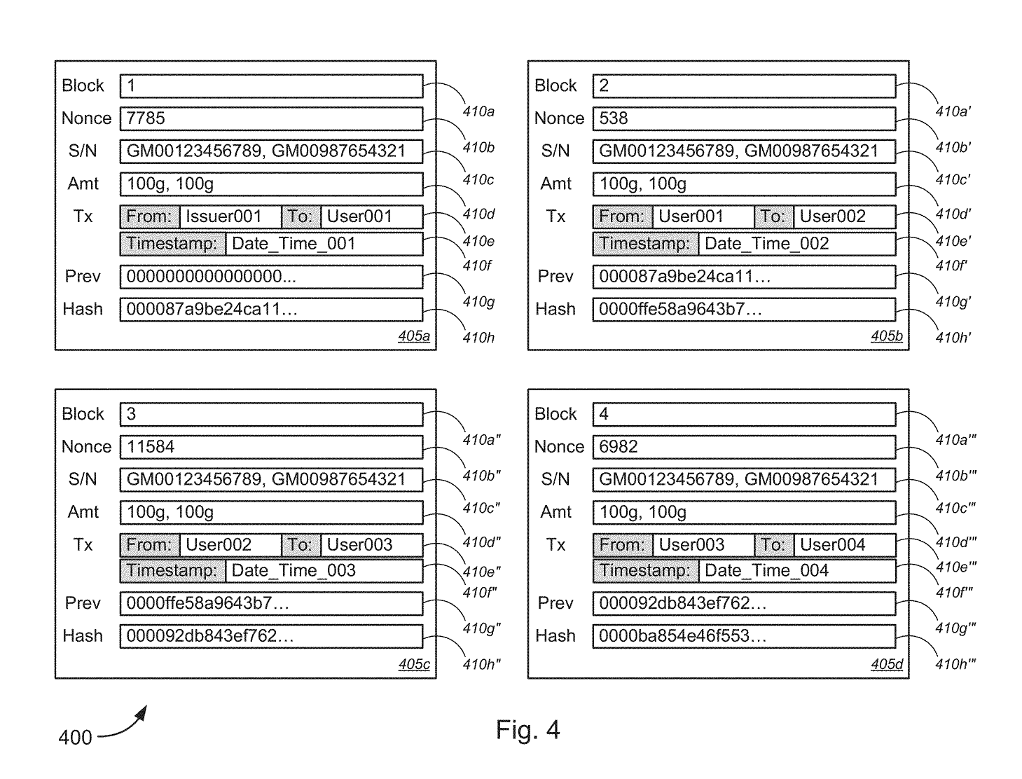

In operation, the computing system 105 might access a plurality of instances of a blockchain, each instance of the blockchain being accessed from a local digital currency data store 1100 and/or a distributed digital currency data store 110 among a plurality of distributed digital currency data stores 110₁-110_{N}. The blockchain might comprise a plurality of blocks, each block comprising a hash value corresponding to encryption of both data that is encapsulated in said block and a previous hash value corresponding to encryption of data and hash value of a preceding block in the blockchain. Non-limiting examples of a blockchain (illustrating the hash values and such) can be seen in the embodiments of FIGS. 3 and 4, which are described below. According to some embodiments, data of a block and hash value of a previous block in the blockchain might be encrypted to produce a hash value, using a cryptographic hash function including, without limitation, one of secure hash algorithm-1 (“SHA-1”) standard (e.g., a 160-bit hash function, or the like), SHA-2 standard (e.g., SHA-256, SHA-512, SHA-224, SHA-384, SHA-512/224, SHA 512/256, and/or the like), or SHA-3 standard (having same hash lengths as SHA-2 but differing in internal structure compared with the rest of the SHA family of standards), and/or the like.

The computing system 105 might receive a request from a user (e.g., from user device(s) 125a-125n, or the like) for a digital currency transaction; might validate an instance of the blockchain containing a hash of a first block, the first block comprising a first identifier associated with a first piece of a precious metal (one of the precious metals 150 and 155, or the like); might add a block to the blockchain, the added block comprising a second identifier associated with the user and a timestamp of the transaction; might encrypt the added block with a cryptographic hash; and might update the blockchain across the plurality of digital currency data stores 110. In some instances, the first identifier might be physically marked on the first piece of the precious metal via one of ultraviolet (“UV”) marking, stamping, chemical etching, milling, mechanical engraving, or laser engraving, and/or the like. In some cases, the first identifier comprises at least one of a serial number, an alphanumeric code, a bar code, a quick response (“QR”) code, or a symbol, and/or the like, where the first identifier associated with each of a plurality of pieces of precious metals is unique.

In some embodiments, camera(s) 160 might capture an image of the first identifier as physically marked on the first piece of the precious metal (one of the precious metals 150 and 155, or the like), in some cases while the first piece of the precious metal is being stored in vault(s) 145 (or between casting, minting, or marking (with identification information and/or hallmarking symbols, or the like) of the first piece of the precious metal and storage in the vault(s) 145). The second computing system 135 might analyze the captured image of the first identifier to generate an encodable version of the first identifier. The second computing system 135 might then send the generated encodable version of the first identifier to the first computing system 105. According to some embodiments, the first computing system 105 might receive a first identifier associated with a first piece of a precious metal; might generate a first block of a blockchain, by adding the received first identifier to the first block; might encrypt the generated first block of the blockchain using a cryptographic hash; and might store the blockchain in each of a plurality of digital currency data stores. In some cases, receiving the first identifier associated with the first piece of the precious metal might comprise receiving, with the first computing system, the generated encodable version of the first identifier, and adding the received first identifier to the first block might comprise adding the generated encodable version of the first identifier to the first block.

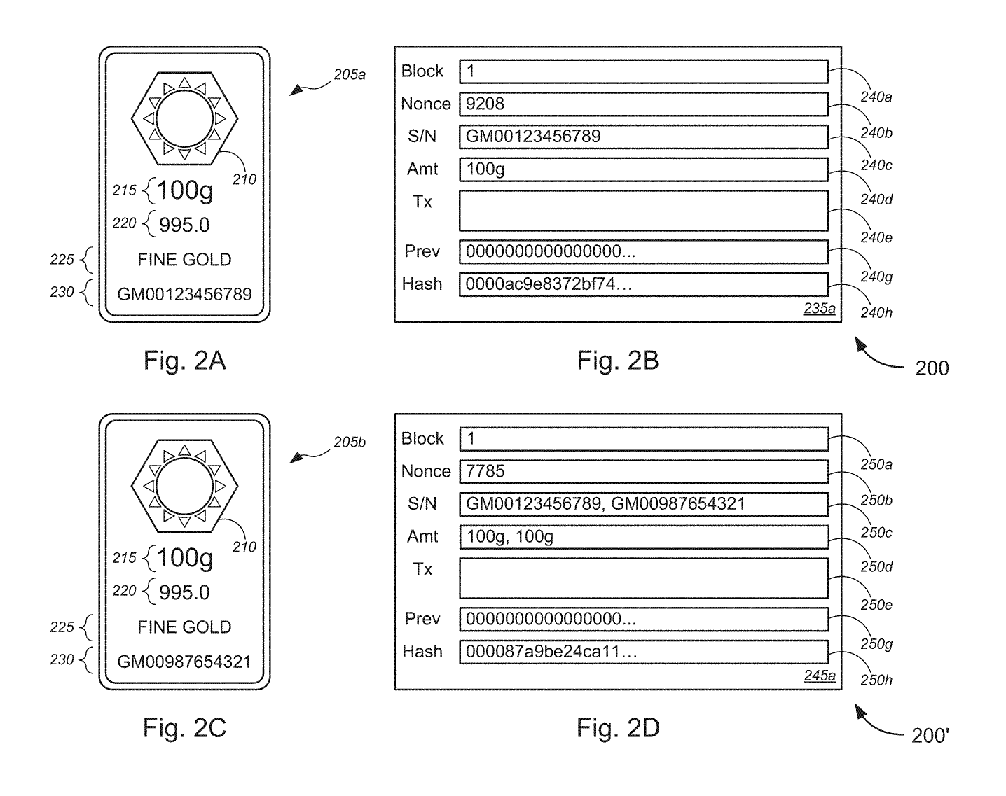

These and other functionalities of the various embodiments are described in detail below with respect to FIGS. 2-6.

FIGS. 2A-2D (collectively, “FIG. 2”) are schematic diagrams illustrating various embodiments 200 and 200′ of digital currency tied to physical precious metals.

With reference to the non-limiting embodiment 200 of FIGS. 2A and 2B, a first piece of a precious metal 205a (in this case, a minted bar of gold) might comprise markings or hallmarks, including, but not limited to, at least one of a sponsor's or maker's mark 210 (sometimes referred to as a hallmark), a size or weight mark 215, a standard or fineness mark 220 (which may be represented in parts per 1000), mark indicating type of precious metal 225 (in this case, “fine gold,” which is gold that is almost pure, i.e., gold having a purity equal to or above a fineness rating of 900), or a serial or registration number mark 230, and/or the like. Other markings (although not shown) might include, without limitation, assay office marks, carat marks (which is an alternative representation of fineness), date mark (indicating year the article is made), traditional marks indicative of type of precious metal, commemorative marks celebrating major events, international convention marks, common control marks, duty marks, draw back marks, or import marks, and/or the like.

In this non-limiting example, a minted gold bar having a weight of 100 g, a fineness value of 995 (i.e., meaning that it is 99.5% pure gold, which falls under the category of “fine gold”), and a serial number of “GM00123456789” is depicted. Although gold is depicted in FIG. 2, the various embodiments are not so limited, and the precious metal can be any precious metal including, but not limited to, one of gold, silver, platinum, palladium, ruthenium, rhodium, iridium, osmium, rhenium, indium, or electrum (which is a naturally occurring alloy of gold and silver, but can be manufactured), and/or the like. Although a rectangular minted bar is shown in FIG. 2, the various embodiments are not so limited, and the precious metal 205 can be of any shape, including, without limitation, a “brick” (such as a “good delivery” bar or the like), a bar, a round or coin, an oval, a boat, a block bar, a rectangle, a square bar, a twin-coin symbol, a yin-yang symbol, a bone, a donut, a coil, a honeycomb, a plate, a fillet, a model (e.g., animal-shaped model, or the like), a heart, a pendant, a double-pendant, a leaf, a talisman, or any suitable or desirable geometric shape, and/or the like. Although the precious metal 205 is depicted in FIG. 2 as being minted, the various embodiments are not so limited, and the precious metal 205 may be minted, cast, compressed cast, in bas-relief, or the like. Further, although the precious metal 205 is depicted in FIG. 2 as having a weight of 100 g, the various embodiments are not so limited, and the precious metal 205 may be of any suitable weight, including, but not limited to, 400 oz or 12.5 kg (as in a “good delivery” bar or the like), 100 oz (as in a “COMEX good delivery” bar or the like), 3000 g (as in a “Shanghai good delivery” bar or the like), 1000 g (i.e., a “kilobar”), 500 g, 250 g, 100 g, 50 g, 10 g, 3.75 oz or 116.64 g (as in a “tola bar” or the like), 1.20337 oz or 37.429 g (as in a “tael bar” or the like), 6.017 oz or 187.15 g (as in a “5 tael biscuit” or the like), 4.901 oz or 152.44 g (as in a “baht bar” or the like), 4.901 oz or 152.44 g (as in a “10 baht biscuit” or the like), and/or the like. In general, the weight of the precious metal 205 can range between 0.25 oz (or 7.087 g) to 400 oz (or 11,340 g), or more, and in some cases can range between 0.3 g to 25 kg, or more. According to some embodiments, the precious metal 205 may have security features added to it, including, but not limited to, multi-colored hologram designs, a Kinegram® (i.e., two-dimensional image that diffracts light at different angles), full-color designs, serial numbers (which is denoted in FIG. 2 by reference numeral 230), and/or the like. In some embodiments, the serial number may be embodied by an identifier that includes, without limitation, at least one of a serial number, an alphanumeric code, a bar code, a quick response (“QR”) code, or a symbol, and/or the like.

With reference to FIG. 2B, a block 235a (in this case, “block #1”) of a blockchain 235 is depicted. Herein, a blockchain, as understood by those having ordinary skill in the art, is in general a decentralized and distributed digital record or ledger that is used to track or record transactions (or other data) across many computers so that the record cannot be altered retroactively without notice or without alteration of all subsequent blocks and collusion by others in the network. This is accomplished by the inherent nature of the hash value of a block (and the previous hash value) changing when even one character is changed in the data portion of the block (that includes, without limitation, deleting one or more characters, adding one or more characters, changing one or more characters, and/or the like). Because each subsequent block in the blockchain relies on the previous hash value to generate a current hash value for that block, each and every block following the changed block (even if “mined” to find a nonce value that makes the hash value start with 4 zeros (i.e., “0000”) and thus to generate a signed block) will be “broken,” i.e., will have a previous hash value that changes, thus resulting in a hash value that does not start with 4 zeros (i.e., “0000”) until mined.

In the non-limiting embodiment 200 of FIG. 2B, the first block 235a of the blockchain 235 might include, without limitation, a block number field 240a (which, in this example, contains the value, “1”), a nonce field 240b (which contains a value that is used to offset the hash value so that the first four characters of the hash value are each “0”; which, in this example, contains the value, “9208”), an identifier or serial number field 240c (which, in this example, contains a serial number value, “GM00123456789,” which corresponds to the identifier or serial number associated with the first piece of precious metal 205a as shown in FIG. 2A), an amount or weight field 240d (which lists the weight of the first piece of precious metal 205a to which the blockchain 235 is tied), a token or data field 240e (which might contain transaction information associated with the first piece of precious metal 205a to which the blockchain 235 is tied), a previous hash field 240g (which contains the hash value of the preceding block; with block #1 having a previous hash value of “0000000000000000 . . . ”), and a current hash field 240h (which contains a hash value of the current block 235a, i.e., a hash of the data encapsulated in the block and the previous hash value (which in some cases contains at least the data in the token or data field 240e, and in some instances may also contain the data in the identifier or serial number field 240c and the amount or weight field 240d as well); which, in this example, contains the value, “0000ac9e8372bf74 . . . ”), and/or the like. According to some embodiments, data of a block (including data contained in the data field 240e, and in some cases also data contained in the identifier field 240c and the amount field 240d, or the like) and hash value of a previous block in the blockchain might be encrypted to produce a hash value, using a cryptographic hash function including, without limitation, one of secure hash algorithm-1 (“SHA-1”) standard (e.g., a 160-bit hash function, or the like), SHA-2 standard (e.g., SHA-256, SHA-512, SHA-224, SHA-384, SHA-512/224, SHA 512/256, and/or the like), or SHA-3 standard (having same hash lengths as SHA-2 but differing in internal structure compared with the rest of the SHA family of standards), and/or the like.

Referring to FIGS. 2C and 2D, a single blockchain need not be tied to a single piece of precious metal as shown in FIGS. 2A and 2B. Rather, a blockchain, such as blockchain 245 may be tied to two or more pieces of precious metals. In the non-limiting embodiment of FIG. 2, blockchain 245 might be tied to the first piece of precious metal(s) 205a and a second piece of precious metal(s) 205b, as illustrated by the identifier or serial number field of the first block 245a of blockchain 245 containing the identifier values or serial numbers of both the first and second pieces of the precious metal(s) 205a and 205b (namely, “GM01223456789” and “GM00987654321”). Turning to FIG. 2C, a second piece of a precious metal 205b, like the first piece of the precious metal 205a, (in this case, a minted bar of gold, like the first piece 205a) might comprise markings or hallmarks, including, but not limited to, at least one of a sponsor's or maker's mark 210 (sometimes referred to as a hallmark), a size or weight mark 215, a standard or fineness mark 220 (which may be represented in parts per 1000), mark indicating type of precious metal 225 (in this case, “fine gold,” which is gold that is almost pure, i.e., gold having a purity equal to or above a fineness rating of 900), or a serial or registration number mark 230, and/or the like. Other markings (although not shown) might include, without limitation, assay office marks, carat marks (which is an alternative representation of fineness), date mark (indicating year the article is made), traditional marks indicative of type of precious metal, commemorative marks celebrating major events, international convention marks, common control marks, duty marks, draw back marks, or import marks, and/or the like.

With reference to the non-limiting embodiment 200′ of FIG. 2D, the first block 245a of the blockchain 245 might include, without limitation, a block number field 250a (which, in this example, contains the value, “1”), a nonce field 250b (which contains a value that is used to offset the hash value so that the first four characters of the hash value are each “0”; which, in this example, contains the value, “7785”), the identifier or serial number field 250c (which, in this example, contains a serial number value, “GM00123456789,” which corresponds to the identifier or serial number associated with the first piece of precious metal 205a as shown in FIG. 2A, as well as a serial number value, “GM00987654321,” which corresponds to the identifier or serial number associated with the second piece of precious metal 205b as shown in FIG. 2C), an amount or weight field 250d (which lists the weight of the first piece of precious metal 205a as well as the weight of the second piece of precious metal 205b to which the blockchain 245 is tied), a token or data field 250e (which might contain transaction information associated with the first piece of precious metal 205a and the second piece of precious metal 205b to which the blockchain 245 is tied), a previous hash field 250g (which contains the hash value of the preceding block; with block #1 having a previous hash value of “0000000000000000 . . . ”), and a current hash field 250h (which contains a hash value of the current block 245a, i.e., a hash of the data encapsulated in the block and the previous hash value (which in some cases contains at least the data in the token or data field 250e, and in some instances may also contain the data in the identifier or serial number field 250c and the amount or weight field 250d as well); which, in this example, contains the value, “000087a9be24ca11 . . . ”), and/or the like. According to some embodiments, as described above with respect to the blockchain 235, data of a block (including data contained in the data field 250e, and in some cases also data contained in the identifier field 250c and the amount field 250d, or the like) and hash value of a previous block in the blockchain might be encrypted to produce a hash value, using a cryptographic hash function including, without limitation, one of secure hash algorithm-1 (“SHA-1”) standard (e.g., a 160-bit hash function, or the like), SHA-2 standard (e.g., SHA-256, SHA-512, SHA-224, SHA-384, SHA-512/224, SHA 512/256, and/or the like), or SHA-3 standard (having same hash lengths as SHA-2 but differing in internal structure compared with the rest of the SHA family of standards), and/or the like.

As shown in FIG. 2, the blockchain 235 is tied to the physical piece of precious metal 205a and/or 205b, as depicted in FIGS. 2A and 2C. In this manner, a digital currency (also referred to as cryptocurrency) may be tied to a value inherent to precious metals, and thus avoids the arbitrary valuations of typical cryptocurrencies that are wholly virtual and divorced from physical valuations.

FIGS. 3 and 4 depict non-limiting embodiments of blockchains that are tied to physical pieces of precious metals. In particular, FIG. 3 is a schematic diagram illustrating an embodiment 300 of a blockchain that is tied to a physical piece of a precious metal, while FIG. 4 is a schematic diagram illustrating another embodiment 400 of a blockchain that is tied to two or more physical pieces of precious metals.

With reference to the non-limiting embodiment 300 of FIG. 3, an instance of a blockchain 305 is illustrated, with blockchain 305 being depicted with four blocks 305a, 305b, 305c, and 305d (although the number of blocks is merely illustrative and is not intended to limit the invention to a blockchain of only four blocks, and can be applicable to blockchains having any number of blocks, from dozens, to scores, to hundreds, to thousands, or more, etc.), each block comprising a block number field 310a, 310a′, 310a″, or 310a″ (which, in this example, contains the value, “1,” “2,” “3,” or “4,” respectively), a nonce field 310b, 310b′, 310b″, or 310b′″ (which contains a value that is used to offset the hash value so that the first four characters of the hash value are each “0”; in this example, block #1 305a might contain a nonce value of “9208,” while block #2 305b might contain a nonce value of “2846,” block #3 305c might contain a nonce value of “7785,” and block #4 305d might contain a nonce value of “15283,” or the like), an identifier or serial number field 310c, 310c′, 310c″, or 310c″ (which, in this example, each contains a serial number value, “GM00123456789,” which corresponds to the identifier or serial number associated with the first piece of precious metal 205a as shown in FIG. 2A, or the like), an amount or weight field 310d, 310d′, 310d″, or 310d″ (which lists the weight of the first piece of precious metal 205a of FIG. 2A or the like to which the blockchain 305 is tied; in this case, 100 g), token or data fields 310e, 310e′, 310e″, or 310e′″ and 310f, 310f, 310f″, or 310f″ (which might contain transaction information associated with the first piece of precious metal 205a of FIG. 2A or the like to which the blockchain 305 is tied), a previous hash field 310g, 310g′, 310g″, or 310g′″ (which contains the hash value of the preceding block; with block #1 having a previous hash value of “0000000000000000 . . . ,” block #2 having a previous hash value of “0000ac9e8372bf74 . . . ,” block #3 having a previous hash value of “0000125b9ef3a24c . . . ,” and block #4 having a previous hash value of “0000538a56b8ed99 . . . ,” or the like), and a current hash field 310h, 310h′, 310h″, or 310h′″ (which contains a hash value of the current block 305a, 305b, 305c, or 305d, i.e., a hash of the data encapsulated in the block and the previous hash value (which in some cases contains at least the data in the token or data fields 310e, 310e, 310e″, or 310e″ and in some instances may also contain the data in the identifier or serial number field 310c, 310c′, 310c″, or 310c″ and the amount or weight field 310d, 310d′, 310d″, or 310d′″ as well); with block #1, in this example, having a current hash value of “0000ac9e8372bf74 . . . ,” block #2 having a previous hash value of “0000125b9ef3a24c . . . ,” block #3 having a previous hash value of “0000538a56b8ed99 . . . ,” and block #4 having a previous hash value of “00007838ce536da7 . . . ,” or the like), and/or the like. According to some embodiments, data of a block (including data contained in the data fields 310e, 310e′, 310e″, or 310e′″ and 310f, 310f, 310f″, or 310f″, and in some cases also data contained in the identifier field 310c, 310c′, 310c″, or 310c″ and the amount field 310d, 310d, 310d″, or 310d″, or the like) and hash value of a previous block in the blockchain might be encrypted to produce a hash value, using a cryptographic hash function including, without limitation, one of secure hash algorithm-1 (“SHA-1”) standard (e.g., a 160-bit hash function, or the like), SHA-2 standard (e.g., SHA-256, SHA-512, SHA-224, SHA-384, SHA-512/224, SHA 512/256, and/or the like), or SHA-3 standard (having same hash lengths as SHA-2 but differing in internal structure compared with the rest of the SHA family of standards), and/or the like.

In the non-limiting example of FIG. 3, the token or data fields might contain transaction information with ownership of the first piece of precious metal 205a of FIG. 2A (having an identifier or serial number of “GM00123456789” and a weight of 100 g). For example, as shown in block #1 305a, ownership of the first piece of precious metal is depicted as being transferred from an issuer, bank, repository, refinery, and/or the like having a user or entity identifier (denoted in FIG. 3 generally as “Issuer001”) to a first user or entity having a user or entity identifier (denoted in FIG. 3 generally as “User001”) (as shown in field 310e), the transaction having a date and/or time stamp (denoted in FIG. 3 generally as “Date_Time_001”; although any one or more date and/or time stamp formats may be implemented to record the date and time of transaction) (as shown in field 310f). The identifiers in field 310e might include, without limitation, at least one of, a name, a pseudonym, a user ID number, an entity ID number, an anonymous user ID number, an anonymous entity ID number, and/or the like. The date and/or time information in field 310f may be of any suitable date and/or time format. Similarly, as shown in block #2 305b, ownership of the first piece of precious metal is depicted as being transferred from the first user (i.e., “User001”) to a second user or entity having a user or entity identifier (denoted in FIG. 3 generally as “User002”) (as shown in field 310e′), the transaction having a date and/or time stamp (denoted in FIG. 3 generally as “Date_Time_002”; although any one or more date and/or time stamp formats may be implemented to record the date and time of transaction) (as shown in field 310f). Likewise, as shown in block #3 305c, ownership of the first piece of precious metal is depicted as being transferred from the second user (i.e., “User002”) to a third user or entity having a user or entity identifier (denoted in FIG. 3 generally as “User003”) (as shown in field 310e″), the transaction having a date and/or time stamp (denoted in FIG. 3 generally as “Date_Time_003”; although any one or more date and/or time stamp formats may be implemented to record the date and time of transaction) (as shown in field 310f″). In a similar manner, as shown in block #4 305d, ownership of the first piece of precious metal is depicted as being transferred from the third user (i.e., “User003”) to a fourth user or entity having a user or entity identifier (denoted in FIG. 3 generally as “User004”) (as shown in field 310e′″), the transaction having a date and/or time stamp (denoted in FIG. 3 generally as “Date_Time_004”; although any one or more date and/or time stamp formats may be implemented to record the date and time of transaction) (as shown in field 310f″). And so on.

Referring to the non-limiting embodiment 400 of FIG. 4, an instance of a blockchain 405 is illustrated, with blockchain 405 being depicted with four blocks 405a, 405b, 405c, and 405d (although the number of blocks is merely illustrative and is not intended to limit the invention to a blockchain of only four blocks, and can be applicable to blockchains having any number of blocks, from dozens, to scores, to hundreds, to thousands, or more, etc.), each block comprising a block number field 410a, 410a′, 410a″, or 410a″ (which, in this example, contains the value, “1,” “2,” “3,” or “4,” respectively), a nonce field 410b, 410b′, 410b″, or 410b′″ (which contains a value that is used to offset the hash value so that the first four characters of the hash value are each “0”; in this example, block #1 405a might contain a nonce value of “7785,” while block #2 405b might contain a nonce value of “538,” block #3 405c might contain a nonce value of “11584,” and block #4 405d might contain a nonce value of “6982,” or the like), an identifier or serial number field 410c, 410c′, 410c″, or 410c″ (which, in this example, each contains a first serial number value, “GM00123456789,” which corresponds to the identifier or serial number associated with the first piece of precious metal 205a as shown in FIG. 2A, or the like and a second serial number value, “GM00987654321,” which corresponds to the identifier or serial number associated with the second piece of precious metal 205b as shown in FIG. 2C, or the like), an amount or weight field 410d, 410d′, 410d″, or 410d″ (which lists the weight of the first piece of precious metal 205a of FIG. 2A and the weight of the second piece of precious metal 205b of FIG. 2C, or the like, to which the blockchain 405 is tied; in this case, 100 g for each), token or data fields 410e, 410e′, 410e″, or 410e″ and 410f, 410f, 410f″, or 410f″ (which might contain transaction information associated with the first piece of precious metal 205a of FIG. 2A and the second piece of precious metal 205b of FIG. 2C, or the like to which the blockchain 405 is tied), a previous hash field 410g, 410g, 410g″, or 410g′″ (which contains the hash value of the preceding block; with block #1 having a previous hash value of “0000000000000000 . . . ,” block #2 having a previous hash value of “000087a9be24ca11 . . . ,” block #3 having a previous hash value of “0000ffe58a9643b7 . . . ,” and block #4 having a previous hash value of “000092db843ef762 . . . ,” or the like), and a current hash field 410h, 410h, 410h″, or 410h″ (which contains a hash value of the current block 405a, 405b, 405c, or 405d, i.e., a hash of the data encapsulated in the block and the previous hash value (which in some cases contains at least the data in the token or data fields 410e, 410e, 410e″, or 410e″ and in some instances may also contain the data in the identifier or serial number field 410c, 410c′, 410c″, or 410c″ and the amount or weight field 410d, 410d′, 410d″, or 410d″ as well); with block #1, in this example, having a current hash value of “000087a9be24ca11 . . . ,” block #2 having a previous hash value of “0000ffe58a9643b7 . . . ,” block #3 having a previous hash value of “000092db843ef762 . . . ,” and block #4 having a previous hash value of “0000ba854e46f553 . . . ,” or the like), and/or the like. According to some embodiments, data of a block (including data contained in the data fields 410e, 410e, 410e″, or 410e″ and 410f, 410f, 410f″, or 410f″, and in some cases also data contained in the identifier field 410c, 410c′, 410c″, or 410c″ and the amount field 410d, 410d, 410d″, or 410d″, or the like) and hash value of a previous block in the blockchain might be encrypted to produce a hash value, using a cryptographic hash function including, without limitation, one of secure hash algorithm-1 (“SHA-1”) standard (e.g., a 160-bit hash function, or the like), SHA-2 standard (e.g., SHA-256, SHA-512, SHA-224, SHA-384, SHA-512/224, SHA 512/256, and/or the like), or SHA-3 standard (having same hash lengths as SHA-2 but differing in internal structure compared with the rest of the SHA family of standards), and/or the like.

In the non-limiting example of FIG. 4, the token or data fields might contain transaction information with ownership of the first piece of precious metal 205a of FIG. 2A (having an identifier or serial number of “GM00123456789” and a weight of 100 g) and the second piece of precious metal 205b of FIG. 2C (having an identifier or serial number of “GM00987654321” and a weight of 100 g). For example, as shown in block #1 405a, ownership of the first piece of precious metal and the second piece of precious metal is depicted as being transferred from an issuer, bank, repository, refinery, and/or the like having a user or entity identifier (denoted in FIG. 4 generally as “Issuer001”) to a first user or entity having a user or entity identifier (denoted in FIG. 4 generally as “User001”) (as shown in field 410e), the transaction having a date and/or time stamp (denoted in FIG. 4 generally as “Date_Time_001”; although any one or more date and/or time stamp formats may be implemented to record the date and time of transaction) (as shown in field 4100. The identifiers in field 410e might include, without limitation, at least one of, a name, a pseudonym, a user ID number, an entity ID number, an anonymous user ID number, an anonymous entity ID number, and/or the like. The date and/or time information in field 410f may be of any suitable date and/or time format. Similarly, as shown in block #2 405b, ownership of the first piece of precious metal and the second piece of precious metal is depicted as being transferred from the first user (i.e., “User001”) to a second user or entity having a user or entity identifier (denoted in FIG. 4 generally as “User002”) (as shown in field 410e′), the transaction having a date and/or time stamp (denoted in FIG. 4 generally as “Date_Time_002”; although any one or more date and/or time stamp formats may be implemented to record the date and time of transaction) (as shown in field 410f). Likewise, as shown in block #3 405c, ownership of the first piece of precious metal and the second piece of precious metal is depicted as being transferred from the second user (i.e., “User002”) to a third user or entity having a user or entity identifier (denoted in FIG. 4 generally as “User003”) (as shown in field 410e″), the transaction having a date and/or time stamp (denoted in FIG. 4 generally as “Date_Time_003”; although any one or more date and/or time stamp formats may be implemented to record the date and time of transaction) (as shown in field 410f″). In a similar manner, as shown in block #4 405d, ownership of the first piece of precious metal and the second piece of precious metal is depicted as being transferred from the third user (i.e., “User003”) to a fourth user or entity having a user or entity identifier (denoted in FIG. 4 generally as “User004”) (as shown in field 410e″), the transaction having a date and/or time stamp (denoted in FIG. 4 generally as “Date_Time_004”; although any one or more date and/or time stamp formats may be implemented to record the date and time of transaction) (as shown in field 410f″). And so on. Although two pieces of precious metal are shown being tied to blockchain 405, the various embodiments are not so limited, and any number of pieces of any type (or combination of types) of precious metal may be tied to a blockchain, and such a blockchain may be transacted between or amongst any number of users or entities as necessary or as desired. Each such transaction would be tied to the value of the physical pieces of precious metal(s), thus providing a measure of financial stability, particularly over cryptocurrencies or digital currencies that have no ties to real-world objects or valuables.

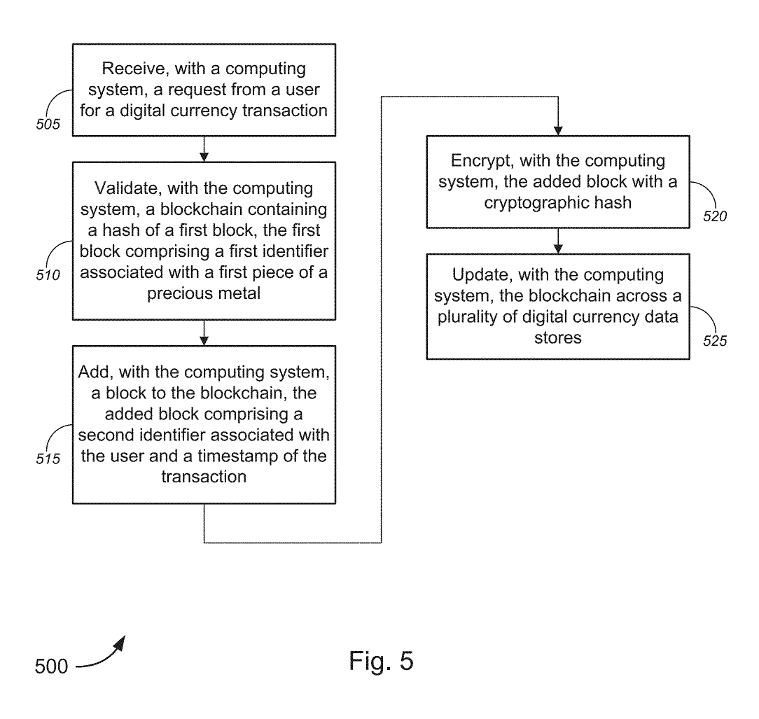

FIG. 5 is a flow diagram illustrating a method 500 for implementing digital currency tied to physical pieces of precious metals, in accordance with various embodiments.

While the techniques and procedures are depicted and/or described in a certain order for purposes of illustration, it should be appreciated that certain procedures may be reordered and/or omitted within the scope of various embodiments. Moreover, while the method 500 illustrated by FIG. 5 can be implemented by or with (and, in some cases, are described below with respect to) the systems or embodiments 100, 200 or 200′, 300, and 400 of FIGS. 1, 2, 3, and 4, respectively (or components thereof), such methods may also be implemented using any suitable hardware (or software) implementation. Similarly, while each of the systems or embodiments 100, 200 or 200′, 300, and 400 of FIGS. 1, 2, 3, and 4, respectively (or components thereof), can operate according to the method 500 illustrated by FIG. 5 (e.g., by executing instructions embodied on a computer readable medium), the systems or embodiments 100, 200 or 200′, 300, and 400 of FIGS. 1, 2, 3, and 4 can each also operate according to other modes of operation and/or perform other suitable procedures.

In the non-limiting embodiment of FIG. 5, method 500 might comprise, at block 505, receiving, with a computing system, a request from a user for a digital currency transaction. In some cases, receiving the request from the user for the digital currency transaction might comprise receiving the request from the user via a user device comprising one of a laptop computer, a tablet computer, a smart phone, a mobile phone, a personal digital assistant, or a portable gaming device, and/or the like.

At block 510, method 500 might comprise validating, with the computing system, a blockchain containing a hash of a first block, the first block comprising a first identifier associated with a first piece of a precious metal. Merely by way of example, the precious metal might include, without limitation, one of gold, silver, platinum, palladium, ruthenium, rhodium, iridium, osmium, rhenium, indium, or electrum (which is a naturally occurring alloy of gold and silver, but can be manufactured), and/or the like. In various embodiments, the piece of the precious metal may be physically stored in a secure vault with other pieces of precious metals. In some instances, the first identifier might be physically marked on the first piece of the precious metal via one of ultraviolet (“UV”) marking, stamping, chemical etching, milling, mechanical engraving, or laser engraving, and/or the like. In some cases, the first identifier comprises at least one of a serial number, an alphanumeric code, a bar code, a quick response (“QR”) code, or a symbol, and/or the like, where the first identifier associated with each of a plurality of pieces of precious metals is unique.

According to some embodiments, validating the blockchain might comprise determining, with the computing system, whether a master instance of the blockchain is accessible, the master instance being an updated instance of the blockchain that has previously been validated; and, based on a determination that the master instance of the blockchain is accessible, comparing, with the computing system, the blockchain with the master instance of the blockchain. The blockchain is validated if the blockchain matches the master instance of the blockchain. In some cases, comparing the blockchain with the master instance of the blockchain might comprise comparing hash values of one or more blocks of the blockchain with hash values of corresponding one or more blocks of the master instance of the blockchain.

Alternatively, validating the blockchain might comprise comparing, with the computing system, the blockchain with each of a plurality of instances of the blockchain, each instance of which is stored in one of the plurality of digital currency data stores. The blockchain is validated if the blockchain matches a majority of the plurality of instances of the blockchain. In some instances, comparing the blockchain with each of the plurality of instances of the blockchain might comprise comparing hash values of one or more blocks of the blockchain with hash values of corresponding one or more blocks of each of the plurality of instances of the blockchain.

Method 500, at block 515, might comprise adding, with the computing system, a block to the blockchain, the added block comprising a second identifier associated with the user and a timestamp of the transaction. Method 500 might further comprise encrypting, with the computing system, the added block with a cryptographic hash (block 520) and updating, with the computing system, the blockchain across a plurality of digital currency data stores (block 525). In some embodiments, encrypting the added block with the cryptographic hash might comprise encrypting the added block to produce a hash value, using a cryptographic hash function comprising one of secure hash algorithm-1 (“SHA-1”) standard, SHA-2 standard, or SHA-3 standard, and/or the like.

In the case of validation by comparison with a master instance of the blockchain, adding the block to the blockchain (at block 515) might be performed only if the blockchain has been validated, and updating the blockchain across the plurality of digital currency data stores (at block 525) might comprise replacing the master instance of the blockchain with the blockchain after the block has been added and encrypted.

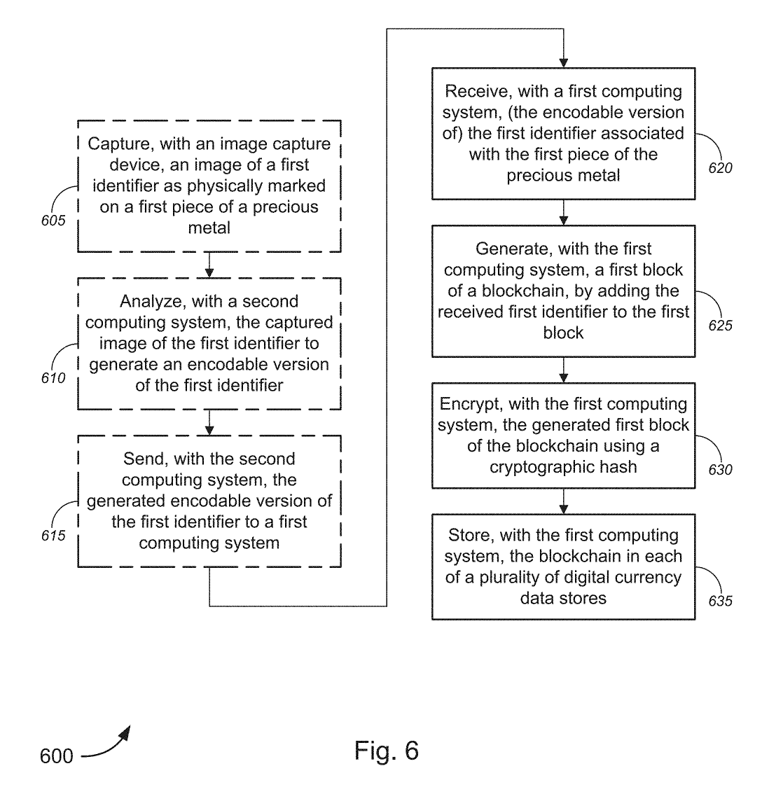

FIG. 6 is a flow diagram illustrating another method 600 for implementing digital currency tied to physical pieces of precious metals, in accordance with various embodiments.

While the techniques and procedures are depicted and/or described in a certain order for purposes of illustration, it should be appreciated that certain procedures may be reordered and/or omitted within the scope of various embodiments. Moreover, while the method 600 illustrated by FIG. 6 can be implemented by or with (and, in some cases, are described below with respect to) the systems or embodiments 100, 200 or 200′, 300, and 400 of FIGS. 1, 2, 3, and 4, respectively (or components thereof), such methods may also be implemented using any suitable hardware (or software) implementation. Similarly, while each of the systems or embodiments 100, 200 or 200′, 300, and 400 of FIGS. 1, 2, 3, and 4, respectively (or components thereof), can operate according to the method 600 illustrated by FIG. 6 (e.g., by executing instructions embodied on a computer readable medium), the systems or embodiments 100, 200 or 200′, 300, and 400 of FIGS. 1, 2, 3, and 4 can each also operate according to other modes of operation and/or perform other suitable procedures.

In the non-limiting embodiment of FIG. 6, method 600 might comprise capturing, with an image capture device, an image of a first identifier as physically marked on a first piece of a precious metal (optional block 605); analyzing, with a second computing system, the captured image of the first identifier to generate an encodable version of the first identifier (e.g., using image to text and/or image to symbol recognition techniques, or the like) (optional block 610); and sending, with the second computing system, the generated encodable version of the first identifier to a first computing system (optional block 615).

Method 600, at block 620, might comprise receiving, with a first computing system, the first identifier associated with the first piece of the precious metal (in some cases, receiving, with the first computing system, the generated encodable version of the first identifier that is associated with the first piece of the precious metal, or the like). At block 625, method 600 might comprise generating, with the first computing system, a first block of a blockchain, by adding the received first identifier to the first block (in some cases, adding, with the first computing system, the generated encodable version of the first identifier to the first block, or the like). Method 600 might further comprise encrypting, with the first computing system, the generated first block of the blockchain using a cryptographic hash (block 630) and storing, with the first computing system, the blockchain in each of a plurality of digital currency data stores (block 635).

Merely by way of example, the precious metal might include, without limitation, one of gold, silver, platinum, palladium, ruthenium, rhodium, iridium, osmium, rhenium, indium, or electrum (which is a naturally occurring alloy of gold and silver, but can be manufactured), and/or the like. In various embodiments, the piece of the precious metal may be physically stored in a secure vault with other pieces of precious metals. In some instances, the first identifier might be physically marked on the first piece of the precious metal via one of ultraviolet (“UV”) marking, stamping, chemical etching, milling, mechanical engraving, or laser engraving, and/or the like. In some cases, the first identifier comprises at least one of a serial number, an alphanumeric code, a bar code, a quick response (“QR”) code, or a symbol, and/or the like, where the first identifier associated with each of a plurality of pieces of precious metals is unique.

In some embodiments, encrypting the generated first block might comprise encrypting the generated first block to produce a hash value, using a cryptographic hash function comprising one of secure hash algorithm-1 (“SHA-1”) standard, SHA-2 standard, or SHA-3 standard, and/or the like.

Exemplary System and Hardware Implementation

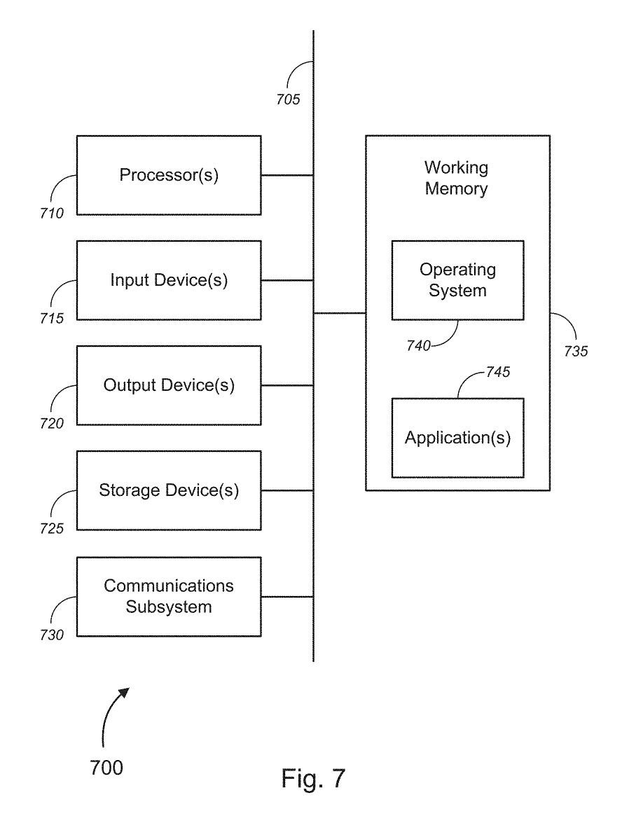

FIG. 7 is a block diagram illustrating an exemplary computer or system hardware architecture, in accordance with various embodiments. FIG. 7 provides a schematic illustration of one embodiment of a computer system 700 of the service provider system hardware that can perform the methods provided by various other embodiments, as described herein, and/or can perform the functions of computer or hardware system (i.e., computing system 105, user devices 125a-125n, and second computing system 135, etc.), as described above. It should be noted that FIG. 7 is meant only to provide a generalized illustration of various components, of which one or more (or none) of each may be utilized as appropriate. FIG. 7, therefore, broadly illustrates how individual system elements may be implemented in a relatively separated or relatively more integrated manner.

The computer or hardware system 700—which might represent an embodiment of the computer or hardware system (i.e., computing system 105, user devices 125a-125n, and second computing system 135, etc.), described above with respect to FIGS. 1-6—is shown comprising hardware elements that can be electrically coupled via a bus 705 (or may otherwise be in communication, as appropriate). The hardware elements may include one or more processors 710, including, without limitation, one or more general-purpose processors and/or one or more special-purpose processors (such as microprocessors, digital signal processing chips, graphics acceleration processors, and/or the like); one or more input devices 715, which can include, without limitation, a mouse, a keyboard, and/or the like; and one or more output devices 720, which can include, without limitation, a display device, a printer, and/or the like.

The computer or hardware system 700 may further include (and/or be in communication with) one or more storage devices 725, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer or hardware system 700 might also include a communications subsystem 730, which can include, without limitation, a modem, a network card (wireless or wired), an infra-red communication device, a wireless communication device and/or chipset (such as a Bluetooth™ device, an 802.11 device, a WiFi device, a WiMax device, a WWAN device, cellular communication facilities, etc.), and/or the like. The communications subsystem 730 may permit data to be exchanged with a network (such as the network described below, to name one example), with other computer or hardware systems, and/or with any other devices described herein. In many embodiments, the computer or hardware system 700 will further comprise a working memory 735, which can include a RAM or ROM device, as described above.

The computer or hardware system 700 also may comprise software elements, shown as being currently located within the working memory 735, including an operating system 740, device drivers, executable libraries, and/or other code, such as one or more application programs 745, which may comprise computer programs provided by various embodiments (including, without limitation, hypervisors, VMs, and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 725 described above. In some cases, the storage medium might be incorporated within a computer system, such as the system 700. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 700 and/or might take the form of source and/or installable code, which, upon compilation and/or installation on the computer or hardware system 700 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 700) to perform methods in accordance with various embodiments of the invention. According to a set of embodiments, some or all of the procedures of such methods are performed by the computer or hardware system 700 in response to processor 710 executing one or more sequences of one or more instructions (which might be incorporated into the operating system 740 and/or other code, such as an application program 745) contained in the working memory 735. Such instructions may be read into the working memory 735 from another computer readable medium, such as one or more of the storage device(s) 725. Merely by way of example, execution of the sequences of instructions contained in the working memory 735 might cause the processor(s) 710 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 700, various computer readable media might be involved in providing instructions/code to processor(s) 710 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 725. Volatile media includes, without limitation, dynamic memory, such as the working memory 735. In some alternative embodiments, a computer readable medium may take the form of transmission media, which includes, without limitation, coaxial cables, copper wire, and fiber optics, including the wires that comprise the bus 705, as well as the various components of the communication subsystem 730 (and/or the media by which the communications subsystem 730 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 710 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 700. These signals, which might be in the form of electromagnetic signals, acoustic signals, optical signals, and/or the like, are all examples of carrier waves on which instructions can be encoded, in accordance with various embodiments of the invention.

The communications subsystem 730 (and/or components thereof) generally will receive the signals, and the bus 705 then might carry the signals (and/or the data, instructions, etc. carried by the signals) to the working memory 735, from which the processor(s) 705 retrieves and executes the instructions. The instructions received by the working memory 735 may optionally be stored on a storage device 725 either before or after execution by the processor(s) 710.

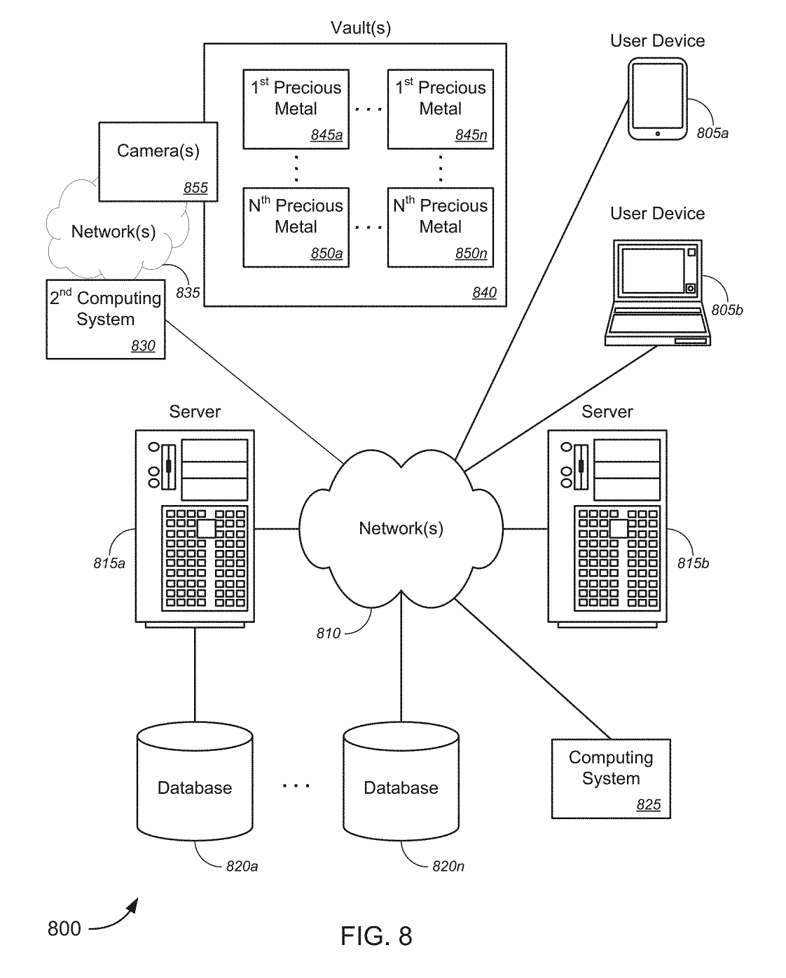

As noted above, a set of embodiments comprises methods and systems for implementing digital currency, and, more particularly, to methods, systems, and apparatuses for implementing digital currency tied to physical precious metals. FIG. 8 illustrates a schematic diagram of a system 800 that can be used in accordance with one set of embodiments. The system 800 can include one or more user computers, user devices, or customer devices 805. A user computer, user device, or customer device 805 can be a general purpose personal computer (including, merely by way of example, desktop computers, tablet computers, laptop computers, handheld computers, and the like, running any appropriate operating system, several of which are available from vendors such as Apple, Microsoft Corp., and the like), cloud computing devices, a server(s), and/or a workstation computer(s) running any of a variety of commercially-available UNIX™ or UNIX-like operating systems. A user computer, user device, or customer device 805 can also have any of a variety of applications, including one or more applications configured to perform methods provided by various embodiments (as described above, for example), as well as one or more office applications, database client and/or server applications, and/or web browser applications. Alternatively, a user computer, user device, or customer device 805 can be any other electronic device, such as a thin-client computer, Internet-enabled mobile telephone, and/or personal digital assistant, capable of communicating via a network (e.g., the network(s) 810 described below) and/or of displaying and navigating web pages or other types of electronic documents. Although the exemplary system 800 is shown with two user computers, user devices, or customer devices 805, any number of user computers, user devices, or customer devices can be supported.

Certain embodiments operate in a networked environment, which can include a network(s) 810. The network(s) 810 can be any type of network familiar to those skilled in the art that can support data communications using any of a variety of commercially-available (and/or free or proprietary) protocols, including, without limitation, TCP/IP, SNA™, IPX™, AppleTalk™, and the like. Merely by way of example, the network(s) 810 (similar to network(s) 115a-115n, 120, 130, and 140 of FIG. 1, or the like) can each include a local area network (“LAN”), including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network might include an access network of the service provider (e.g., an Internet service provider (“ISP”)). In another embodiment, the network might include a core network of the service provider, and/or the Internet.

Embodiments can also include one or more server computers 815. Each of the server computers 815 may be configured with an operating system, including, without limitation, any of those discussed above, as well as any commercially (or freely) available server operating systems. Each of the servers 815 may also be running one or more applications, which can be configured to provide services to one or more clients 805 and/or other servers 815.

Merely by way of example, one of the servers 815 might be a data server, a web server, a cloud computing device(s), or the like, as described above. The data server might include (or be in communication with) a web server, which can be used, merely by way of example, to process requests for web pages or other electronic documents from user computers 805. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 805 to perform methods of the invention.

The server computers 815, in some embodiments, might include one or more application servers, which can be configured with one or more applications accessible by a client running on one or more of the client computers 805 and/or other servers 815. Merely by way of example, the server(s) 815 can be one or more general purpose computers capable of executing programs or scripts in response to the user computers 805 and/or other servers 815, including, without limitation, web applications (which might, in some cases, be configured to perform methods provided by various embodiments). Merely by way of example, a web application can be implemented as one or more scripts or programs written in any suitable programming language, such as Java™, C, C#™ or C++, and/or any scripting language, such as Perl, Python, or TCL, as well as combinations of any programming and/or scripting languages. The application server(s) can also include database servers, including, without limitation, those commercially available from Oracle™, Microsoft™, Sybase™, IBM™, and the like, which can process requests from clients (including, depending on the configuration, dedicated database clients, API clients, web browsers, etc.) running on a user computer, user device, or customer device 805 and/or another server 815. In some embodiments, an application server can perform one or more of the processes for implementing digital currency, and, more particularly, to methods, systems, and apparatuses for implementing digital currency tied to physical precious metals, as described in detail above. Data provided by an application server may be formatted as one or more web pages (comprising HTML, JavaScript, etc., for example) and/or may be forwarded to a user computer 805 via a web server (as described above, for example). Similarly, a web server might receive web page requests and/or input data from a user computer 805 and/or forward the web page requests and/or input data to an application server. In some cases, a web server may be integrated with an application server.

In accordance with further embodiments, one or more servers 815 can function as a file server and/or can include one or more of the files (e.g., application code, data files, etc.) necessary to implement various disclosed methods, incorporated by an application running on a user computer 805 and/or another server 815. Alternatively, as those skilled in the art will appreciate, a file server can include all necessary files, allowing such an application to be invoked remotely by a user computer, user device, or customer device 805 and/or server 815.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 820a-820n (collectively, “databases 820”). The location of each of the databases 820 is discretionary: merely by way of example, a database 820a might reside on a storage medium local to (and/or resident in) a server 815a (and/or a user computer, user device, or customer device 805). Alternatively, a database 820n can be remote from any or all of the computers 805, 815, so long as it can be in communication (e.g., via the network 810) with one or more of these. In a particular set of embodiments, a database 820 can reside in a storage-area network (“SAN”) familiar to those skilled in the art. (Likewise, any necessary files for performing the functions attributed to the computers 805, 815 can be stored locally on the respective computer and/or remotely, as appropriate.) In one set of embodiments, the database 820 can be a relational database, such as an Oracle database, that is adapted to store, update, and retrieve data in response to SQL-formatted commands. The database might be controlled and/or maintained by a database server, as described above, for example.

According to some embodiments, system 800 might further comprise a computing system 825, second computing system 830 in network(s) 835, vault(s) 840, a plurality of a first type of precious metals 845a-845n (collectively, “precious metals 845” or the like) through a plurality of an N^{th} type of precious metals 850a-850n (collectively, “precious metals 850” or the like) stored in vault(s) 840, and camera(s) 855 in network(s) 835 (and communicatively coupled to the second computing system 830) with views of the precious metals 845 and 850 in vault(s) 840. In some cases, the one or more user devices 805a and 805b might each include, without limitation, one of a laptop computer, a tablet computer, a smart phone, a mobile phone, a personal digital assistant, or a portable gaming device, or the like.

In operation, computing system 825 might access the plurality of instances of the blockchain each from a digital currency data store among the plurality of distributed digital currency data stores (e.g., database 820a-820n, or the like), in some cases via server 815a or 815b and network(s) 810, or the like. The computing system 825 might receive a request from a user (from user device(s) 805a and/or 805b, or the like) for a digital currency transaction; might validate an instance of the blockchain containing a hash of a first block, the first block comprising a first identifier associated with a first piece of a precious metal (one of the precious metals 845 or 850, or the like); might add a block to the blockchain, the added block comprising a second identifier associated with the user and a timestamp of the transaction; might encrypt the added block with a cryptographic hash; and might update the blockchain across a plurality of digital currency data stores.

In some embodiments, camera(s) 855 might capture an image of the first identifier as physically marked on the first piece of the precious metal (one of the precious metals 845 or 850, or the like). The second computing system 830 might analyze the captured image of the first identifier to generate an encodable version of the first identifier. The second computing system 830 might then send the generated encodable version of the first identifier to the first computing system 825. According to some embodiments, the first computing system 825 might receive a first identifier associated with a first piece of a precious metal; might generate a first block of a blockchain, by adding the received first identifier to the first block; might encrypt the generated first block of the blockchain using a cryptographic hash; and might store the blockchain in each of a plurality of digital currency data stores. In some cases, receiving the first identifier associated with the first piece of the precious metal might comprise receiving, with the first computing system, the generated encodable version of the first identifier, and adding the received first identifier to the first block might comprise adding the generated encodable version of the first identifier to the first block.

These and other functions of the system 800 (and its components) are described in greater detail above with respect to FIGS. 1-6.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
receiving, with a computing system, a request from a user for a digital currency transaction;
validating, with the computing system, a blockchain containing a hash of a first block, the first block comprising a first identifier associated with a first piece of a precious metal;
adding, with the computing system, a block to the blockchain, the added block comprising a second identifier associated with the user and a timestamp of the transaction;
encrypting, with the computing system, the added block with a cryptographic hash; and
updating, with the computing system, the blockchain across a plurality of digital currency data stores.

2. The method of claim 1, wherein encrypting the added block with the cryptographic hash comprises encrypting the added block to produce a hash value, using a cryptographic hash function comprising one of secure hash algorithm-1 (“SHA-1”) standard, SHA-2 standard, or SHA-3 standard.

3. The method of claim 1, wherein receiving the request from the user for the digital currency transaction comprises receiving the request from the user via a user device comprising one of a laptop computer, a tablet computer, a smart phone, a mobile phone, a personal digital assistant, or a portable gaming device.

4. The method of claim 1, wherein validating the blockchain comprises:
determining, with the computing system, whether a master instance of the blockchain is accessible, the master instance being an updated instance of the blockchain that has previously been validated; and
based on a determination that the master instance of the blockchain is accessible, comparing, with the computing system, the blockchain with the master instance of the blockchain;
wherein the blockchain is validated if the blockchain matches the master instance of the blockchain, wherein adding the block to the blockchain is performed only if the blockchain has been validated.

5. The method of claim 4, wherein comparing the blockchain with the master instance of the blockchain comprises comparing hash values of one or more blocks of the blockchain with hash values of corresponding one or more blocks of the master instance of the blockchain.

6. The method of claim 4, wherein updating the blockchain across the plurality of digital currency data stores comprises replacing the master instance of the blockchain with the blockchain after the block has been added and encrypted.

7. The method of claim 1, wherein validating the blockchain comprises:
comparing, with the computing system, the blockchain with each of a plurality of instances of the blockchain, each instance of which is stored in one of the plurality of digital currency data stores;
wherein the blockchain is validated if the blockchain matches a majority of the plurality of instances of the blockchain.

8. The method of claim 7, wherein comparing the blockchain with each of the plurality of instances of the blockchain comprises comparing hash values of one or more blocks of the blockchain with hash values of corresponding one or more blocks of each of the plurality of instances of the blockchain.

9. The method of claim 1, wherein the precious metal comprises one of gold, silver, platinum, palladium, ruthenium, rhodium, iridium, osmium, rhenium, indium, or electrum.

10. The method of claim 1, wherein the piece of the precious metal is physically stored in a secure vault with other pieces of precious metals.

11. The method of claim 1, wherein the first identifier is physically marked on the first piece of the precious metal via one of ultraviolet (“UV”) marking, stamping, chemical etching, milling, mechanical engraving, or laser engraving.

12. The method of claim 1, wherein the first identifier comprises at least one of a serial number, an alphanumeric code, a bar code, a quick response (“QR”) code, or a symbol, wherein the first identifier associated with each of a plurality of pieces of precious metals is unique.

13. An apparatus, comprising:
at least one processor; and
a non-transitory computer readable medium communicatively coupled to the at least one processor, the non-transitory computer readable medium having stored thereon computer software comprising a set of instructions that, when executed by the at least one processor, causes the apparatus to:
receive a request from a user for a digital currency transaction;
validate a blockchain containing a hash of a first block, the first block comprising a first identifier associated with a first piece of a precious metal;
add a block to the blockchain, the added block comprising a second identifier associated with the user and a timestamp of the transaction;
encrypt the added block with a cryptographic hash; and
update the blockchain across a plurality of digital currency data stores.

14. The apparatus of claim 13, wherein encrypting the added block with the cryptographic hash comprises encrypting the added block to produce a hash value, using a cryptographic hash function comprising one of secure hash algorithm-1 (“SHA-1”) standard, SHA-2 standard, or SHA-3 standard.

15. The apparatus of claim 13, wherein receiving the request from the user for the digital currency transaction comprises receiving the request from the user via a user device comprising one of a laptop computer, a tablet computer, a smart phone, a mobile phone, a personal digital assistant, or a portable gaming device.

16. The apparatus of claim 13, wherein validating the blockchain comprises:
determining whether a master instance of the blockchain is accessible, the master instance being an updated instance of the blockchain that has previously been validated; and
based on a determination that the master instance of the blockchain is accessible, comparing the blockchain with the master instance of the blockchain;
wherein the blockchain is validated if the blockchain matches the master instance of the blockchain, wherein adding the block to the blockchain is performed only if the blockchain has been validated.

17. The apparatus of claim 16, wherein comparing the blockchain with the master instance of the blockchain comprises comparing hash values of one or more blocks of the blockchain with hash values of corresponding one or more blocks of the master instance of the blockchain.

18. The apparatus of claim 16, wherein updating the blockchain across the plurality of digital currency data stores comprises replacing the master instance of the blockchain with the blockchain after the block has been added and encrypted.

19. The apparatus of claim 13, wherein validating the blockchain comprises:
comparing the blockchain with each of a plurality of instances of the blockchain, each instance of which is stored in one of the plurality of digital currency data stores;
wherein the blockchain is validated if the blockchain matches a majority of the plurality of instances of the blockchain.

20. The apparatus of claim 19, wherein comparing the blockchain with each of the plurality of instances of the blockchain comprises comparing hash values of one or more blocks of the blockchain with hash values of corresponding one or more blocks of each of the plurality of instances of the blockchain.

21. The apparatus of claim 13, wherein the precious metal comprises one of gold, silver, platinum, palladium, ruthenium, rhodium, iridium, osmium, rhenium, indium, or electrum.

22. The apparatus of claim 13, wherein the piece of the precious metal is physically stored in a secure vault with other pieces of precious metals.

23. The apparatus of claim 13, wherein the first identifier is physically marked on the first piece of the precious metal via one of ultraviolet (“UV”) marking, stamping, chemical etching, milling, mechanical engraving, or laser engraving.

24. The apparatus of claim 13, wherein the first identifier comprises at least one of a serial number, an alphanumeric code, a bar code, a quick response (“QR”) code, or a symbol, wherein the first identifier associated with each of a plurality of pieces of precious metals is unique.

25. A system, comprising:
a plurality of digital currency data stores; and
a computing system, comprising:
at least one first processor; and
a first non-transitory computer readable medium communicatively coupled to the at least one first processor, the first non-transitory computer readable medium having stored thereon computer software comprising a first set of instructions that, when executed by the at least one first processor, causes the computing system to:
receive a request from a user for a digital currency transaction;
validate a blockchain containing a hash of a first block, the first block comprising a first identifier associated with a first piece of a precious metal;
add a block to the blockchain, the added block comprising a second identifier associated with the user and a timestamp of the transaction;
encrypt the added block with a cryptographic hash; and
update the blockchain across the plurality of digital currency data stores;
wherein each digital currency data store storing an instance of the blockchain among a plurality of instances of the blockchain, the blockchain comprising a plurality of blocks, each block comprising a hash value corresponding to encryption of both data that is encapsulated in said block and a previous hash value corresponding to encryption of data and hash value of a preceding block in the blockchain.
